(19) United States
(12) Patent Application Publication
(10) Pub. No.: US 2014/0304625 A1
(43) Pub. Date: Oct. 9, 2014

(54) PAGE RETURNING

(71) Applicant: Alibaba Group Holding Limited, Grand Cayman (KY)

(72) Inventors: Jiqing Ke, Hangzhou (CN); Haijun Jia, Hangzhou (CN)

(73) Assignee: Alibaba Group Holding Limited, Grand Cayman (KY)

(21) Appl. No.: 14/242,682

(22) Filed: Apr. 1, 2014

(30) Foreign Application Priority Data
Apr. 3, 2013 (CN) 201310116139.8

(51) Int. Cl. G06F 17/30; G06F 3/0485

(52) U.S. Cl. CPC G06F 17/30905; G06F 3/0485
USPC 715/760; 715/784

(57) ABSTRACT

The present disclosure discloses an example method and device for page returning. A page scrolling processing is conducted in response to a pull-down operation of a user. When it is detected that a pull-down distance of a page content of a current page is longer than a threshold, a page returning operation is implemented. The present techniques not only cause the process of page returning interactive, playable, and terminable but also add a new universal scroll-down sliding operation to increase the usability of the returning operation.

CROSS REFERENCE TO RELATED PATENT APPLICATIONS

This application claims foreign priority to Chinese Patent Application No. 201310116139.8 filed on 3 Apr. 2013, entitled “Method and Device for Page Returning,” which is hereby incorporated by reference in its entirety.

### TECHNICAL FIELD

The present disclosure is related to communication such as mobile communication, and, more particularly, to a method and a device for page returning at a mobile device.

### BACKGROUND

Currently a mobile device provides a return button at a fixed location of a current page to trigger page returning in an application scenario. When the return button is clicked, the current page is returned to a previous page. Such page switching processes cannot be terminated and lack interactivity. The conventional techniques do not provide an interactive mechanism that uses a universal gesture to return to a page.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present techniques improve diversity of results in the direction technology.

The present disclosure provides an example method for page retuning Such method may be applied at a mobile device. A page scrolling processing is conducted in response to a pull-down operation of a user. When it is detected that a pull-down distance of a page content of a current page is higher than a threshold, a page returning operation is implemented.

For example, the operation of implementing the page scroll processing may include determining whether a header of the page is a mini header. When it is determined that the header of the page is the mini header, the mini header is converted to a normal header.

For example, when determining whether the header of the page is the mini header, the present techniques also determine whether the header of the page is an individualized header. When the header of the page is determined as the individualized header, the individualized header is pulled down so that the pull-down distance is longer than the threshold. When the header of the page is not determined as the individualized header, a distance between a top of the page content of the page and the header of the page is increased so that an increased distance is longer than the threshold.

For example, based on a result of the page scrolling processing, the present techniques may further implement the page returning operation when determining that a time of the pull-down operation is longer than a time threshold.

The present disclosure also provides an example device for page returning. Such device may be applied at a mobile device. The device may include a page scrolling processing apparatus and a threshold detecting apparatus. The page scrolling processing apparatus implements a page scrolling processing in response to a pull-down operation of a user. The threshold detecting apparatus, when detecting that a pull-down distance of content of a current page is longer than a threshold, implements a page returning operation.

For example, the page scrolling processing apparatus may include a first determining apparatus and a converting apparatus. The first determining apparatus determines whether a header of the page is a mini header. When the first determining apparatus determines that the header of the page is the mini header, the converting apparatus converts the mini header to a normal header.

For example, the page scrolling processing apparatus may also include a second determining apparatus, a first implementing apparatus, and a second implementing apparatus. When the first determining apparatus determines that the header of the page is not the mini header, the second determining apparatus determines whether the header of the page is an individualized header. When the second determining apparatus determines that the header of the page is the individualized header, the first implementing apparatus pulls down the individualized header so that the pull-down distance is longer than the threshold. When the second determining apparatus determines that the header of the page is not the individualized header, the second implementing apparatus increases a distance between a top of the content of the page and the header of page is increased so that an increased distance is longer than the threshold.

For example, the threshold may be longer than a maximum stretched distance when the current page is refreshed.

For example, the example device may also include a time detecting apparatus. The time detecting apparatus, based on a result of the page scrolling processing, may determine that a time period of the pull-down operation is longer than a preset time period and implements the page returning operation.

For example, the time period of the pull-down operation may refer to a time period between receiving the pull-down operation from the user and implementing the page returning operation. For instance, the preset time period may be preset between 0 and 400 ms. For another instance, the preset time period may be 200 ms.

The pull-down and return mechanism in the present techniques not only cause the process of page returning interactive, playable, and terminable but also add a new universal scroll-down sliding operation to increase the usability of the returning operation.

### BRIEF DESCRIPTION OF THE DRAWINGS

The FIGS. are used to provide illustration of the present disclosure and thus are part of the present disclosure. The illustrative examples and their explanations are used to illustrate the present disclosure and should not be used to limit the present disclosure.

FIG. 1 is a flowchart illustrating an example method for page returning in accordance with the present disclosure.

FIG. 2 is a flowchart illustrating an example method for implementing a page scrolling process in accordance with the present disclosure.

FIG. 3A is a diagram that illustrates an insertion of a colored transparent mask between a page A and a page B.

FIG. 3B is a diagram that illustrates an insertion a colored transparent mask between the page A and a page C.

FIG. 3C is a diagram that illustrates a complete display of the Page B or the page C at a screen.

FIGS. 4(a)-4(d) are diagrams that show an example normal header and an example mini header at a current page in accordance with the present disclosure.

FIGS. 5(a)-5(c) are diagrams that show an example individualized header at the current page in accordance with the present disclosure.

FIG. 6 is a chart that illustrates an example relationship between a pull-down distance and a responding time of a page change during a pull-down operation in which a touch point between a user and the screen is used as a starting point.

FIGS. 7(a)-(c) shows status diagrams that illustrate an example switch of pages between different applications.

FIG. 8 is a schematic diagram that illustrates an example device for page returning in accordance with the present disclosure.

FIG. 9 is a schematic diagram that illustrates an example page scrolling processing apparatus in accordance with the present disclosure.

### DETAILED DESCRIPTION

The present disclosure provides a method and device for page returning. The present techniques provide a returning mechanism between superior and subordinate pages, which is similar to a page switching mechanism (such as a switch inside a page or a switch between pages of different applications) that, for example, may be used in a cloud operation system such as Yun OS™. The present techniques may have a contextual relationship with a page entry mechanism of the cloud computing system, combine with an individualized header of the cloud computing system to shrink or stretch the individualized header in a top-down pulling process, have a capability of determining a distance of operation path and determining operation time to prevent operations by error.

To better illustrate the purpose, technical plans, and advantages of the present techniques, the following descriptions are described in reference to the FIGs and example embodiments.

The present disclosure provides an example method of page returning. Such method may be applied at a mobile device.

The following description describes a scenario of switching between different pages by reference to the cloud operation system of the mobile device. For example, the cloud operation system may be a Yun OS™.

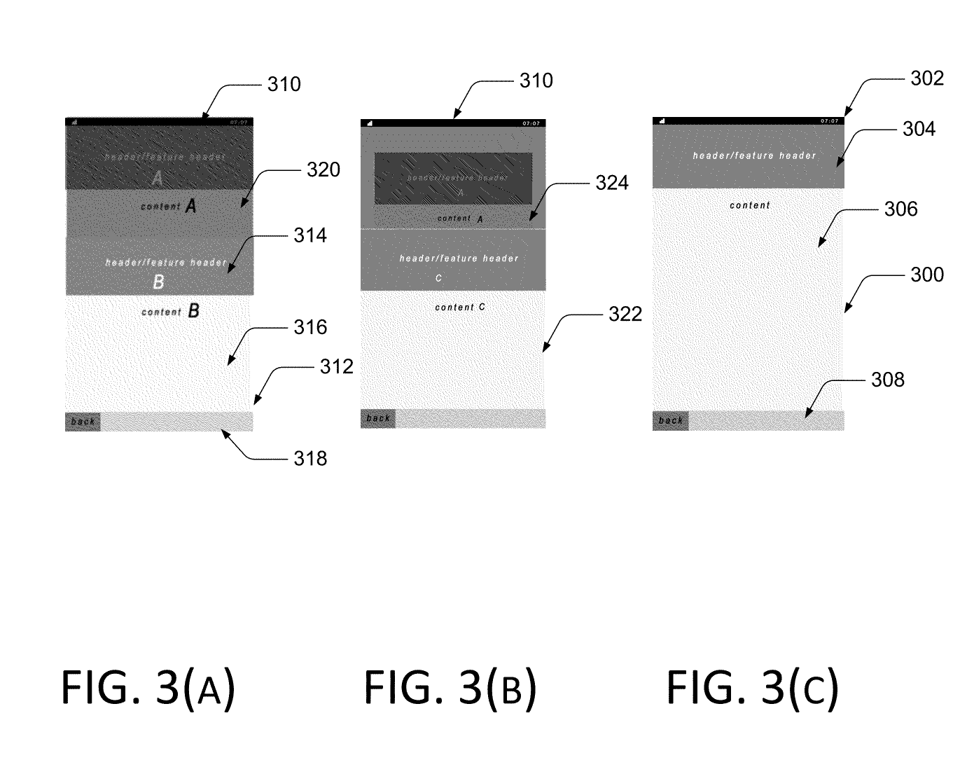

In the operation system of the mobile device (hereinafter also referred to as “system”), such as the Yun OS™ 2.0, a basic layout of a page 300, from top to bottom, may include a status bar 302, a header 304, a content 306, and a footer 308, as shown in FIG. 3C. FIG. 3C illustrate a layout of the current page. There are two example scenarios in page switching between different levels of pages in the system.

A first example scenario is a page switching in a same application. Assuming a user initiates an operation at a current page A 310 to enter into a page B 312 at a next level in the same application, a header 314 and a content 316 of the page B 312 is lifted from a top border of the footer 318 from bottom to top until the page B 312 is completely displayed in a screen of the mobile device. During a process that the page B 312 is lifted, a mask 320 may be inserted between the page A 310 and the page B 312 to differentiate the page A 310 and the page B 312. The mask, for example, may be a colored transparent mask. FIG. 3A illustrates a diagram that a colored transparent mask is inserted between the Page A 310 and the Page B 312. FIG. 3C illustrates a diagram that a page such as the page B 312 that is completely displayed at the screen. Based on the same principles, the process that the page B 312 as a child page returns to the Page A 310 is a reverse process from the page A 310 to the page B 312.

A second example scenario is a page switching between different applications. For example, assuming the user uses a specific operation at the current page A 310 to call another application and thus enters into a page C 322. When the page A 310 is reduced to a certain percentage of its original size, such as 70%, the page C 322 is lifted from the top border of the footer of the page A 310 from bottom to top until the page C 322 is completely displayed in the screen of the mobile device. Similarly, a mask 324 may be inserted between the page A 310 and the page C 322. The mask 324, for example, may be the colored transparent mask. FIG. 3B illustrates a diagram that a colored transparent mask is inserted between the page A 310 and the page C 322. FIG. 3C illustrates a diagram that a page such as the page C 322 is completely displayed at the screen. Similarly, the process that the page C 322 returns to the page A 310 is a reverse process from the page A 310 to the page C 322.

In general, in the example operation system, such as the Yun OS™ 2.0, a process of positive switching for a page is a switching process from bottom to top. In contrast, a process of reverse switching for a page is a switching process from top to bottom. The process of positive switching for the page refers to a switching from the current page to another page that is one level lower than the current page. The process of reverse switching for the current page refers to switching from the current page to another page that is one level higher than the current page.

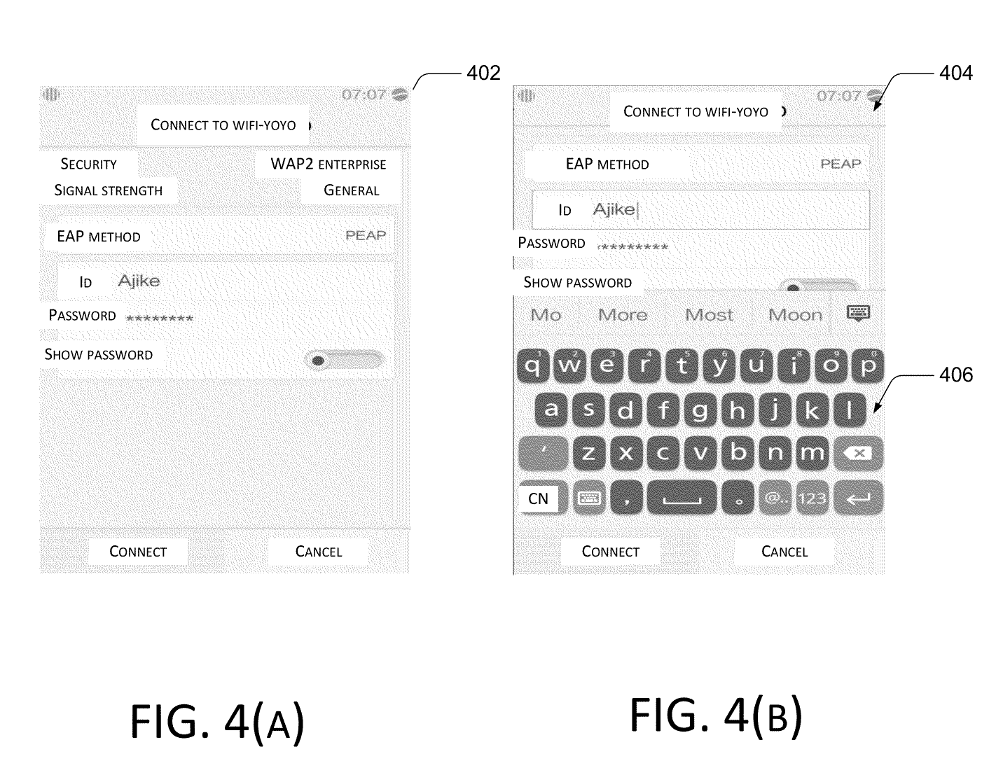

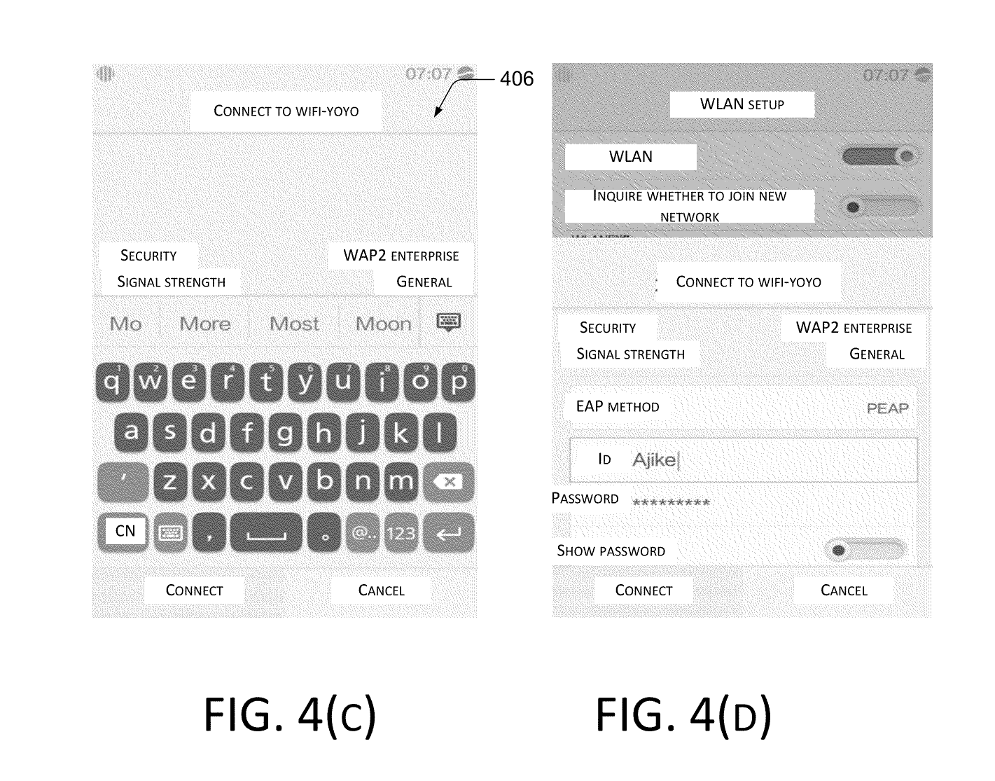

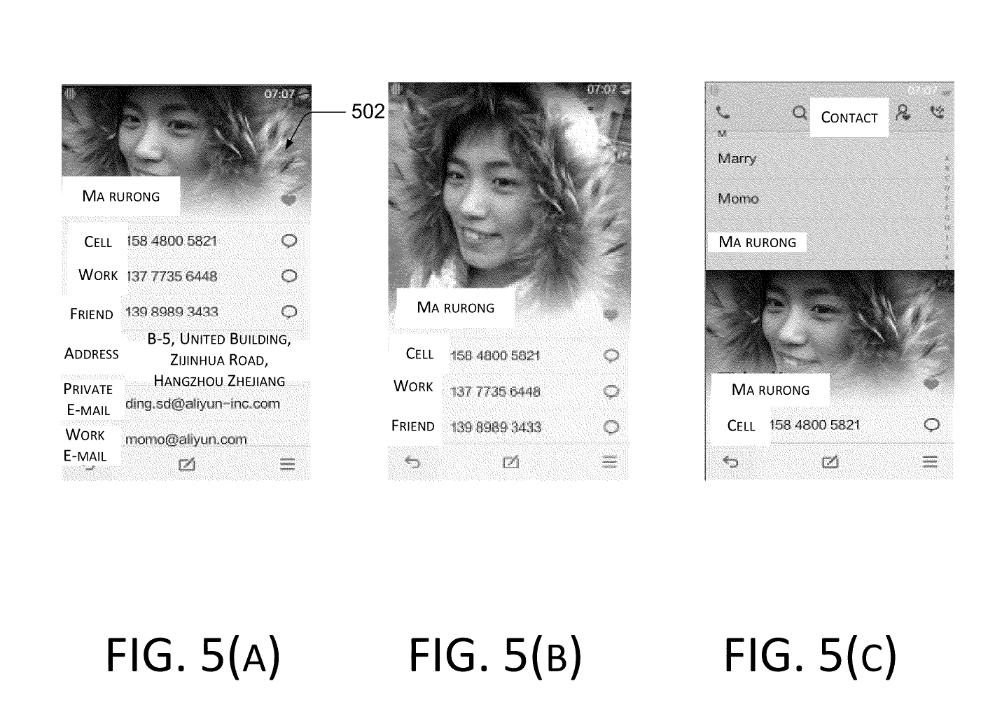

FIGS. 4 and 5 illustrate various headers of the current page that are described in the present disclosure. The header of the current page at the mobile device may be classified into the following three categories: a normal header, a min header, and an individualized header. For example, a normal header 402, as shown in FIG. 4(a), may be a header without a change in height. For instance, the normal header 402 may include navigation information. For example, a mini header 404, as shown in FIG. 4(b), may be a header whose height shrinks when a status of the current page changes. As the page may have different statuses such as viewing, scrolling, editing, and modular status, information displayed at the header of the page may sometimes change according to the status of the header of the page. For instance, only a portion of the information is displayed while another portion of the information is hided. The modular status refers to a status that the page is used to process a special matter. An individualized header 502, as shown in FIG. 5(a), is a header that includes one or more types of information such as a height, a color, a style, a picture, or a size. For example, such information may be individualized.

In addition, according to the status of the page, there may be a switch between the normal header and the min header and a switch between the individualized header and the min header. For example, FIGS. 4(a) and 4(b) illustrate a scenario that the normal header 402 is switched to the mini header 404. Certainly, there may also be a scenario that the mini header is switched to the normal header or the individualized header.

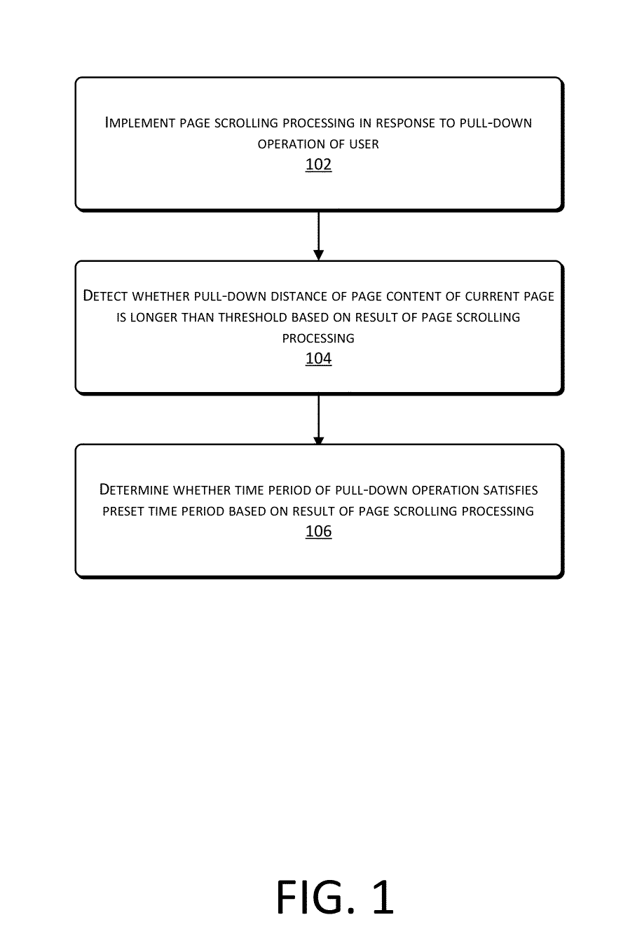

The present disclosure provides a method for page returning at a mobile device. FIG. 1 is a flow chart illustrating an example method for page returning at the mobile device.

At 102, a page scrolling processing is conducted in response to a pull-down operation of a user. The pull-down operation refers to a process from a time that the user uses a finger or a touch pen to touch a screen of the mobile device to a time that the user completes the touching operation. In other words, the user conducts the touching operation to the mobile device. Correspondingly, an operation system of the mobile device responds to the touching operation and implements the page scrolling processing.

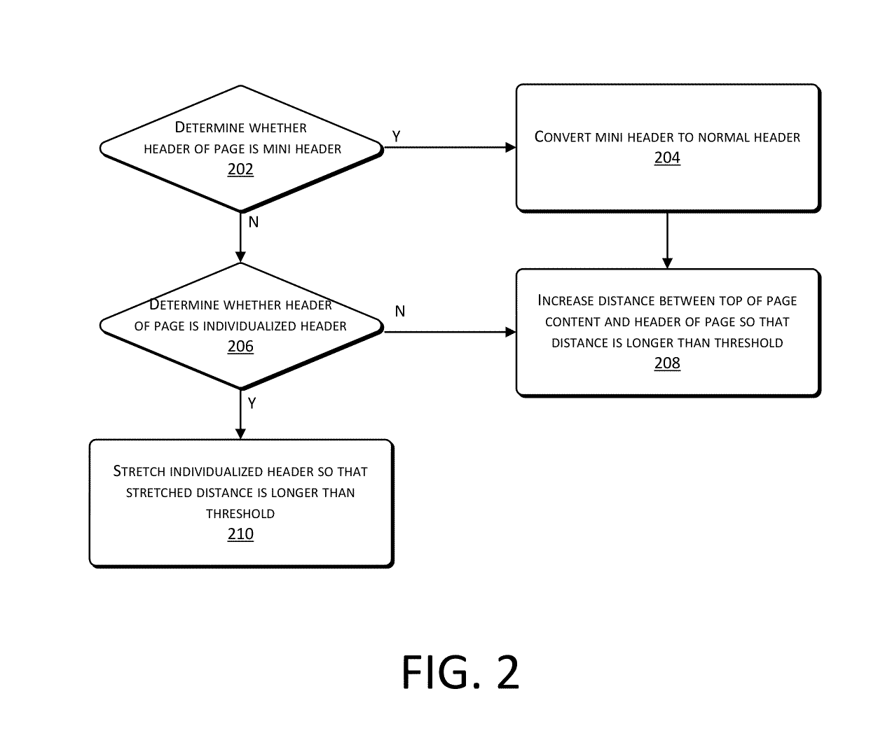

By reference to FIGS. 2-6, the present techniques also illustrate an example process of a reverse switching of the page. FIG. 2 is a flowchart that illustrates an example method for implementing the page scrolling process by the system in accordance with the present disclosure.

As shown in FIG. 2, the page scrolling process implemented by the system may include a first determining operation 202, a switching operation 204, a second determining operation 206, a second implementing operation 208, and a first implementing operation 210.

At the first determining operation 202, it is determined whether the header of the page is the mini header. For example, the mini header refers to a header that the normal header is reduced to a certain size and a portion of the normal header is hided when an input keyboard is displayed at the current page. As shown in FIG. 4, FIG. 4(a) shows the normal header 402 displayed at the current page. FIG. 4(b) shows the mini header 404 displayed at the current page when the input keyboard 406 is displayed at the current page. The first determining operation 202 is initially implemented to ensure that the header of the current page is not the mini header before the page returning operation is implemented, i.e., to ensure that the header displayed at the current page is complete. If it is determined that the header of the page is the mini header, operations at 204 are performed. Otherwise, if a determining result is that the header of the page is not the mini header, the second determining operation 206 is performed. In other words, the switching operation is implemented according to the determining result of the first determining operation 202.

At the switching operation at 204, a switching operation is implemented to switch the mini header to the normal header. For instance, assuming that the current page is the page as shown in FIG. 4(b), the mini header 404 in the current page is switched to the normal header 406 as shown in FIG. 4(c). In other words, the hidden portion in the mini header of the current page is also displayed at the screen. That is, during the switching process, as shown in FIG. 4(c), a height of the header of the page is gradually increased. Meanwhile, a content loaded by the mini header is moved downward. A content loaded by the normal header is moved into the screen from top to bottom. FIG. 4(c) illustrates a diagram of a status that the page content is continued to be pulled down after the mini header of the current page is switched to the normal header.

At the second determining operation 206, it is determined whether the header of the current page is the individualized header. In other words, as the method that the system conducts page returning is different according to the type of the header of the page, there is a need to determine whether the header of the page is the individualized header or the normal header at 206. If it is determined that the header of the current page is the individualized header, the first implementing operation 210 is performed. If it is determined that the header of the current page is the normal header instead of the individualized, the second implementing operation 208 is performed. In other words, when the displayed header of the current page is not the mini header, there are two situations that the header may be the normal header or the individualized header. In such situation, the method for page returning to be initiated is determined according to the displayed header of the current page. For example, the individualized header may be a header that has a special configuration such as including a special image. FIG. 5(a) illustrates an example individualized header displayed at the current page.

At the first implementing operation 210, the individualized header of the current page is pulled down so that a stretched distance is longer than a threshold. FIG. 5(b) illustrates a situation that the individualized header is stretched when the individualized header of the current page is pulled down. In other words, during the process of pull-down operation by the user, the individualized header is stretched along with the pull-down operation. During the stretching process, it is determined whether the stretched distance is longer than the threshold. If the stretched distance is longer than the threshold, as shown in FIG. 5(c), the header of the page is gradually changed to a size of the normal header in certain time, connected with the page content, and moved down along with the content until the current page moves out of the screen and the page that is a level higher than the current page is moved into the screen.

At the second implementing operation 208, a distance between a top of the content of the current page and the header of the page is increased such that the increased distance is longer than the threshold. FIG. 4(d) shows a scenario that the normal header of the current page is pulled down. In other words, during the process of the pull-down operation by the user, the height of the header of the current keeps unchanged and a gap is generated between the content and the normal header. The gap is increased along with the pull-down operation. During the pull-down operation, it is determined whether the increased distance of the gap is longer than the threshold. If the increased distance of the gap is longer than the threshold, the header of the page is connected with the content as a whole within a certain time period and moves down along with the content.

For example, the above described certain time period may refer to a responding time of the page during the process that the content is pulled down. For instance, the certain time period may be set between 0.02 second and 0.5 second. For another instance, the certain time period may be 0.1 second. In addition, for example, the threshold may refer to a threshold value that the stretched distance satisfies implementing the page returning operation when the header of the current page is stretched. An example method for calculating the stretched distance may be as follows:
when the header of the page is the individualized header,
the stretched distance L=a height of the stretched individualized header−a higher of the original individualized header
when the header of the page is the normal header,
the stretched distance L=a height of the gap that is pulled out.

For example, a range of L may be [0, (⅜)*screen height]. When L is higher than a maximum value of the range, the header of the page changes to the original height and is connected with the page content for display as a whole.

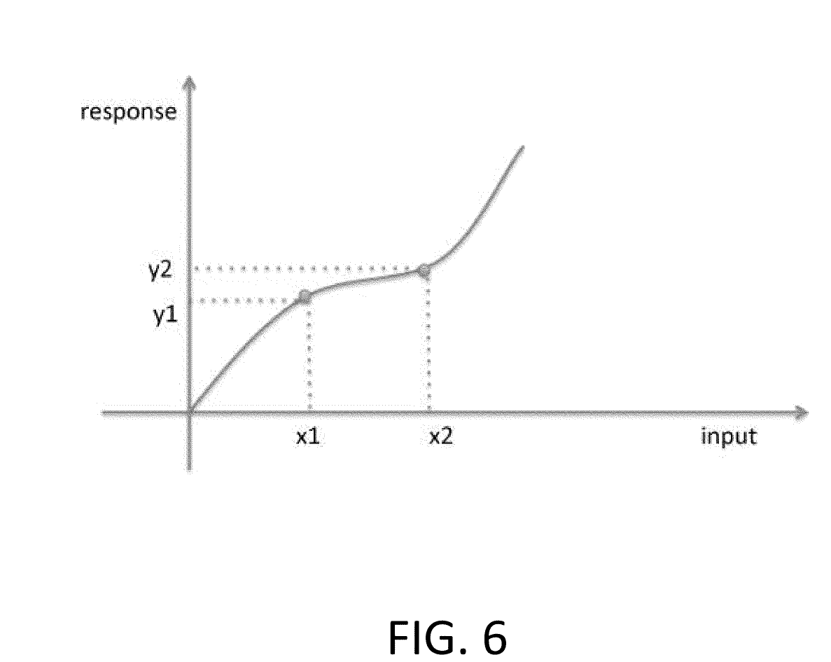

FIG. 6 illustrates a chart that illustrates an example relationship between the pull-down distance by using the touch point between the user and the screen as the starting point and a responding time of a change of the page. As shown in FIG. 6, a horizontal axis represents the pull-down distance when the user conducts the pull-down operation, and a vertical axis represents the responding time of the change of the page. In the example of FIG. 6, X1 represents a maximum elasticity distance that the page content that is normally scrolled and stretched beyond the top of the page content to exceed the border of the header of the page and the content of the page. X2 represents a threshold of the stretched distance that satisfies the condition of implementing page returning operation when the header of the current page is stretched. For example, the threshold may be (⅜)*screen height. Y1 represents a responding time value of the page when the page is refreshed. Y2 represents a responding time value of the page when the stretched distance of the header of the page satisfies the condition of implementing the page returning operation. In the example of FIG. 6, the threshold X2 is higher than the maximum distance X1 that the page is stretched when the page is refreshed. As shown in FIG. 6, when the pull-down distance is between 0 and X1, initially, the page is scrolled down normally. As the pull-down distance is less than the distance that satisfies the page returning operation, the page is elastically switched from a scrolling-down status to its original status. When the pull-down distance is between X1 and X2, the speed of pulling-down turns slow to increase the cost of the page returning operation and prevent the page returning operation from happening due to an operation by error during a normal use process. Under such status, as the pull-down distance still does meet the distance that satisfies the page returning operation, the page is elastically to its original status finally. When the pull-down distance is longer than X2, as the pull-down distance satisfies the distance for the page returning operation, the page returning mechanism is triggered. As the page changing speed is consistent with the moving speed of the pull-down operation by the user, when the user finishes the operation that touches the screen such that the finger leaves the screen, the scrolled page is scrolled down and slides out of the screen to show the complete page that is one level higher than the current page. In other words, the page returning operation is implemented.

The system implements the operations from 202 to 210 to implement the page scrolling-down processing.

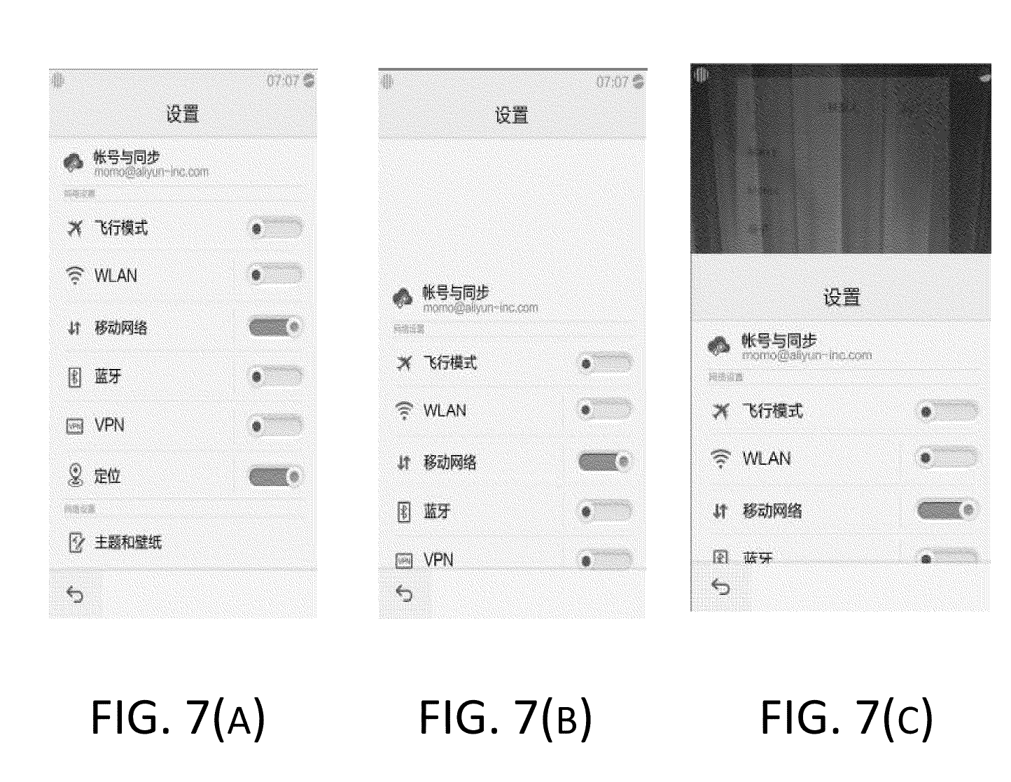

Referring to FIG. 1, at 104, the present techniques detect whether the pull-down distance of page content of current page is longer than the threshold based on the result of page scrolling processing. When the present techniques detect that the pull-down distance of the page content of the current page is longer than the threshold based on the result of the page scrolling processing, the page returning operation is implemented. In other words, responding to the pull-down operation by the user to the current page, the operation system of the mobile device detects the page scrolling distance corresponding to the pull-down distance caused by the pull-down operation of the user and determines whether to implement the page returning operation based on the detecting result. As shown above, at 208 or 210, the stretched distance of the individualized header of the current page or the length of the gap between the header of the page and the page content is longer than the threshold, the system detects that the pull-down distance of the page content of the page is longer than the threshold and thus implements the page returning operation. For example, FIG. 5(c) shows status of implementing the page returning operation in the same application. When the current page is pulled down, the page that is one level above the current page, or the page that has contacts, is moved into the screen. For another example, FIGS. 7(a)-(c) show status diagrams when the page returning operation is implemented in different applications. FIG. 7(a) illustrates the current page displayed at the screen. FIG. 7(b) illustrates a status diagram that the length of the gap between the header and the page content of the current page is increased. FIG. 7(c) illustrates a status diagram that, after the length of the gap is longer than the threshold, when the page content of the current page is moved out of the screen, a page content of another application moves into the screen.

For example, to prevent the page returning from the operation by error in the normal use process and the pull-down operation of the page content at normal status, in addition to detecting whether the pull-down distance of the page content of the current page is longer than the threshold, the present techniques may further determine whether a time period that the page content of the current page is pulled down satisfies a preset time period. In other words, when the user finishes the touching operation, if the moving distance arising from the whole touching operation is longer than the threshold and the pull-down operation time is longer than the preset time period, the page returning operation is triggered. Otherwise, the page is returned to its original status.

As shown in FIG. 1, at 106, the present techniques further determine whether the time period of the pull-down operation satisfies the preset time period based on the result of the page scrolling processing at 102. If the time period of the pull-down operation is longer than the preset time period, the page returning operation is implemented. For example, the time period of the pull-down operation refers to a time period from a time of receiving the pull-down operation from the user to a time that the page returning operation is implemented. Assuming that the time period of the pull-down operation is t, t=t2−t1. t1 represents the time that the user touches the screen. t2 represents the time that the user finishes touching the screen. For example, when the value of t is between [0, 400 ms), t does not satisfy the determining condition. When the value of t is between [400 ms, +∞), t satisfies the determining condition. In other words, the preset time period t may be between 0 and 400 ms. For instance, the preset time period t may be 200 ms.

The above description describes triggering the page returning operation after the user touches the screen of the mobile device. The above description illustrates that the user conducts the pull-down operation to the page content. In addition, when the user conducts the pull-down operation to the header of the page, if the header displayed at the current page is the normalized header, the system does not respond and the page remains the same. If the header displayed at the current page is the individualized header, the system responds to the pull-down operation of the user to stretch the header of the page and determines whether to implement the page returning operation depending on the stretched distance of the header.

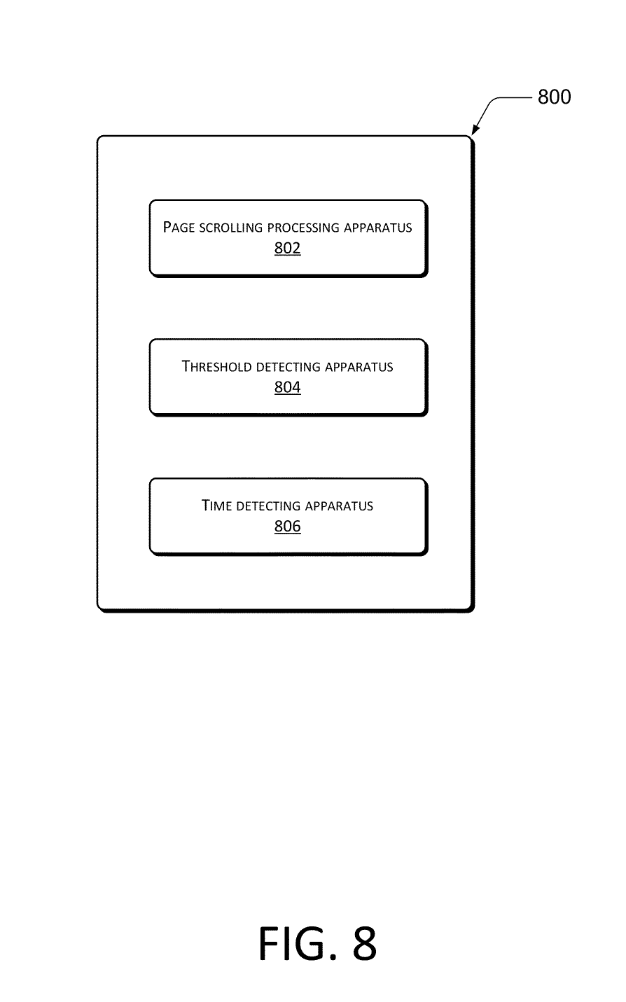

The following describes an example device for page returning. FIG. 8 is a diagram that illustrates an example device 800 for page returning. The device 800 may include a page scrolling processing apparatus 802, a threshold detecting apparatus 804, and a time detecting apparatus 806.

The page scrolling processing apparatus 802 implements a page scrolling processing in response to a pull-down operation of a user.

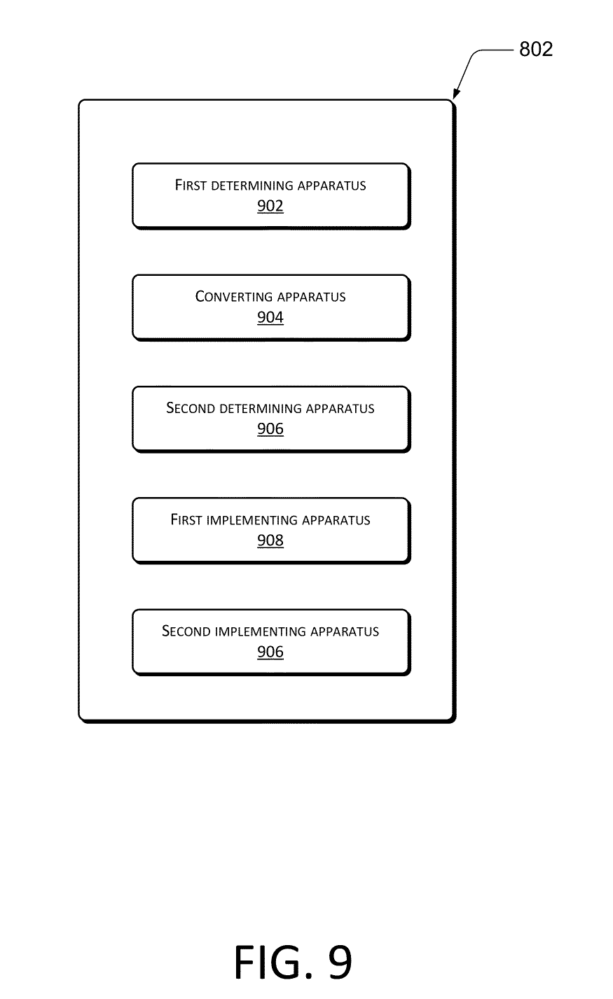

FIG. 9 is a diagram that illustrates the page scrolling processing apparatus 802. As shown in FIG. 9, the page scrolling processing apparatus 802 may include a first determining apparatus 902, a converting apparatus 904, a second determining apparatus 906, a first implementing apparatus 908, and a second implementing apparatus 910.

The first determining apparatus 902 determines whether a header of the page is a mini header. When the first determining apparatus 902 determines that the header of the page is the mini header, the converting apparatus 904 converts the mini header to a normal header.

When the first determining apparatus 902 determines that the header of the page is not the mini header, the second determining apparatus 906 further determines whether the header of the page is an individualized header. When the second determining apparatus 906 determines that the header of the page is the individualized header, the first implementing apparatus 908 pulls down the individualized header so that a stretched distance is higher than a threshold. For example, the threshold may be longer than a maximum of stretched distance when the current page is refreshed.

When the second determining apparatus 906 determines that the header of the page is not the individualized header, the second implementing apparatus 910 increases a distance between a top of the content of the page and the header of the page so that the increased distance is longer than the threshold.

Referring to FIG. 8, the threshold detecting apparatus 804, when detecting that the pull-down distance of content of the current page is longer than the threshold, implements a page returning operation.

The time detecting apparatus 806, based on a result of the page scrolling processing, further determines that a time of the pull-down operation is longer than a preset time period and implements the page returning operation. For example, the time of the pull-down operation may refer to a time period between receiving the pull-down operation from the user and implementing the page returning operation. For instance, the preset time period may be preset between 0-400 ms. For another instance, the preset time period may be preset at 200 ms.

The implementations of the apparatuses in the device 800 correspond to the implementations of operations in the method of the present disclosure. For brevity, the details of each apparatus are not detailed.

Each of the apparatuses may be in the form of software, hardware, or a combination thereof. For example, the device 800 may include one or more processor(s) and memory. The memory is an example of computer-readable media. As used herein, “computer-readable media” includes computer storage media and communication media. Computer storage media includes volatile and non-volatile, removable and non-removable media implemented in any method or technology for storage of information such as computer-executed instructions, data structures, program modules, or other data. In contrast, communication media may embody computer-readable instructions, data structures, program modules, or other data in a modulated data signal, such as a carrier wave. As defined herein, computer storage media does not include communication media. The memory may store therein the above apparatuses in the form of program units or modules and program data.

The methods and devices for page returning as described in the present disclosure may be applied in any application system that is configured to switch the current page to another page. For example, the application systems may include, but are not limited to, a mobile terminal device, a laptop computer, a tablet, a personal digital assistance (PDA), etc.

One of ordinary skill in the art would understand that the modules and operations as described in the present disclosure may be implemented by hardware, computer software, or a combination thereof. To illustrate the interchangeability between hardware and software, the present disclosure generally describes components and operations in each example embodiment according to their functionalities. Whether such functionalities are implemented by hardware or software is dependent on specific applications of technical solutions and design constraints. One of ordinary skill in the art would use different methods for different specific application scenarios to implement the described functionalities. Such implementation shall not be deemed as out of the protection scope of the present disclosure.

The methods or the operations of methods as described in the present disclosure may be implemented through hardware, software modules executed by one or more processors, or a combination thereof. The software module may be stored in random access memory (RAM), internal memory, read-only memory (ROM), programmable read-only memory (PROM), erasable programmable read only memory (EPROM), register storage, hard disk, portable disk, CD-ROM, or any other computer storage media well-known in the art.

The present techniques may be implemented through hardware, software, or a combination thereof. The hardware may be implemented by specific logic. The software may be stored at one or more computer storage media and implemented by a proper instruction implementation system such as one or more processors or specifically designed processing device. One of ordinary skill in the art would understand that the above devices or apparatuses, and methods can be implemented by computer-executable instructions and/or control codes embedded in the processors. For example, disk, CD or DVE-Rom, read-only memory (ROM), programmable read-only memory (PROM) or any other optical or electronic signal carrier media may store such instructions or codes. The devices and their modules may be implemented by very-large-scale integrated circuit or gate array, semiconductors such as logic circuits or transistors, or circuits of programmable hardware device such as field Programmable Gate Array (FPGA), programmable logic device, any other computer-executable instruction executed by the processors, or a combination of any of the above hardware circuits and software.

Although the present disclosure describes several apparatuses, modules or sub-modules of the devices, a division of such apparatuses, modules or sub-modules are not mandatory. For example, functionalities and characteristics of two or more apparatuses or modules may be integrated into one apparatus or module. Functionalities and characteristics of one apparatus or module may be further divided into multiple apparatuses or modules.

Although the present disclosure and the FIGs describe operations in certain sequence, it does not require or imply that the operations have to be implemented according to such sequences or all operations have to be implemented to achieve the desired result. In contrast, some steps in the FIGs may have different implementing sequences. Additionally or optionally, some operations may be omitted; multiple steps may be integrated into one step; or one step is divided into multiple steps.

The above descriptions illustrate example embodiments of the present disclosure. The embodiments are merely for illustrating the example embodiments and are not intended to limit the scope of the present disclosure. It should be understood by one of ordinary skill in the art that certain modifications, replacements, and improvements can be made and should still be considered under the protection of the present disclosure without departing from the principles of the present disclosure.

What is claimed is:

1. A method comprising:
in response to a pull-down operation of a user to a current page, implementing a page scrolling processing; and
in response to detecting that a pull-down distance of a page content of the current page is longer than a threshold based on a result of the page scrolling processing, implementing a page returning operation.

2. The method of claim 1, wherein the implementing the page returning operation includes:
determining whether a header of the current page is a mini header; and
in response to determining that the header of the current page is the mini header, converting the mini header to a normal header.

3. The method of claim 2, wherein the normal header includes a header whose height is not changed.

4. The method of claim 2, wherein the mini header includes a header whose height is reduced from an original height when a status of the current page changes.

5. The method of claim 2, further comprising:
in response to determining that the header of the current page is not the mini header, determining whether the header of the current page is an individualized header;
in response to determining that the header of the current page is the individualized header, stretching the individualized header so that a stretched distance is longer than the threshold; and
in response to determining that the header of the current page is not the individualized header, increasing a distance between a top of the page content and the header of the current page so that the increased distance is longer than the threshold.

6. The method of claim 5, wherein the individualized header includes a header that includes one or more types of information including a height, a color, a style, a picture, or a size.

7. The method of claim 1, wherein the threshold is longer than a maximum stretched distance when the current page is refreshed.

8. The method of claim 1, wherein the implementing the page returning operation comprises:
based on the result of the page scrolling processing, determining that a time period of the pull-down operation is longer than a preset time period; and
implementing the page returning operation.

9. The method of claim 8, wherein the time period of the pull-down operation includes a time period from a time that the pull-down operation is received to a time that the page returning operation is implemented.

10. The method of claim 8, wherein the preset time period is between 0 and 400 ms.

11. The method of claim 8, wherein the preset time period is 200 ms.

12. A device comprising:
a page scrolling processing apparatus that implements a page scrolling processing in response to a pull-down operation of a user; and
a threshold detecting apparatus that, when detecting that a pull-down distance of a page content of a current page is higher than a threshold based on a result of the page scrolling processing, implements a page returning operation.

13. The device of claim 12, wherein the page scrolling apparatus includes:
a first determining apparatus that determines whether a header of the current page is a mini header; and
a converting apparatus, when the first determining apparatus determines that the header of the current page is the mini header, converts the mini header to a normal header.

14. The device of claim 12, wherein the page scrolling apparatus further includes:
a second determining apparatus that, when the first determining apparatus determines that the header of the current page is not the mini header, determines whether the header of the current page is an individualized header;
a first implementing apparatus that, when the second determining apparatus determines that the header of the current page is the individualized header, stretches the individualized header so that a stretched distance is longer than the threshold; and
a second implementing apparatus that, when the second determining apparatus determines that the header of the current page is not the individualized header, increases a distance between a top of the page content and the header of the current page so that the increased distance is longer than the threshold.

15. The device of claim 14, wherein the threshold is longer than a maximum stretched distance when the current page is refreshed.

16. The device of claim 12, further comprising a time detecting apparatus that, in response to determining that a time period of the pull-down operation is longer than a preset time period based on a result of the page scrolling processing, implements the page returning operation.

17. The method of claim 16, wherein the time period of the pull-down operation includes a time period from a time that the pull-down operation is received to a time that the page returning operation is implemented.

18. One or more computer storage media stored thereon computer-executable instructions executable by one or more processors to perform operations comprising:
in response to a pull-down operation of a user to a current page at a screen of a mobile device, implementing a page scrolling processing;
in response to detecting that a pull-down distance of a page content of the current page is longer than a threshold based on a result of the page scrolling processing, determining that a time period of the pull-down operation is longer than a preset time period based on a result of the page scrolling processing;
determining that a time period of the pull-down operation is longer than a preset time period; and
implementing the page returning operation.

19. The one or more computer storage media of claim 18, wherein the implementing the page scrolling processing includes:
determining whether a header of the current page is a mini header; and
in response to determining that the header of the current page is the mini header, converting the mini header to a normal header;
in response to determining that the header of the current page is not the mini header, determining whether the header of the current page is an individualized header;
in response to determining that the header of the current page is the individualized header, stretching the individualized header so that a stretched distance is longer than the threshold; and
in response to determining that the header of the current page is not the individualized header, increasing a distance between a top of the page content and the header of the current page so that the increased distance is longer than the threshold.

20. The one or more computer storage media of claim 18, wherein the threshold is longer than a maximum stretched distance when the current page is refreshed.
